(19) United States
(12) Patent Application Publication
(10) Pub. No.: US 2018/0243727 A1
(43) Pub. Date: Aug. 30, 2018

(54) HYDROGEN PRODUCTION USING HYBRID PHOTONIC-ELECTRONIC MATERIALS

(71) Applicant: SABIC Global Technologies B.V., Bergen op Zoom (NL)

(72) Inventors: Mohd Adnan Khan, Thuwal (SA); Hamdan Al Ghamdi, Thuwal (SA); Ugo Ravon, Thuwal (SA); Hicham Idriss, Thuwal (SA); Maher Al-Oufi, Thuwal (SA)

(21) Appl. No.: 15/756,099

(22) PCT Filed: Aug. 26, 2016
(86) PCT No.: PCT/IB2016/055122

§ 371 Date: Feb. 28, 2018

Related U.S. Application Data
(60) Provisional application No. 62/211,364, filed on Aug. 28, 2015.

(51) Int. Cl. B01J 23/52; B01J 21/06; B01J 35/00; B01J 37/00; B01J 37/02; B01J 37/06; C01B 13/02; C01B 3/04; C25B 1/00; B01J 23/40

(52) U.S. Cl. CPC B01J 23/52; B01J 21/063; B01J 35/0013; B01J 35/004; B01J 37/0018; B01J 37/0201; B01J 23/40; B01J 37/0219; B01J 37/06; C01B 13/0207; C01B 3/042; C25B 1/003; B01J 37/0248

(57) ABSTRACT

Disclosed is a water-splitting photocatalyst, and methods for its use, that includes a photoactive semi-conductive layer, an up-converting material capable of converting infrared (IR) light to visible light and/or ultraviolet (UV) light, and a metal or metal alloy material having surface plasmon resonance properties in response to IR light and/or visible light, wherein the photoactive semi-conductive layer encompasses at least a portion of the up-converting material and the metal or metal alloy material.

### CROSS REFERENCE TO RELATED APPLICATIONS

This application claims the benefit of priority of U.S. Provisional Patent Application No. 62/211,364, filed Aug. 28, 2015, which is hereby incorporated by reference in its entirety.

### BACKGROUND OF THE INVENTION

### A. Field of the Invention

The invention generally concerns a water-splitting photocatalyst. In particular the invention concerns a water-splitting photocatalyst that includes an up-converting material capable of converting infrared (IR) light to visible light and/or ultraviolet (UV) light, a metal or metal alloy material having surface plasmon resonance properties in response to IR light and/or visible light, and a photoactive semi-conductive layer that encompasses at least a portion of the up-converting material and the metal or metal alloy material.

### B. Description of Related Art

Hydrogen production from water offers enormous potential benefits for the energy sector, the environment, and the chemical industry. While methods currently exist for producing hydrogen and oxygen from water, many of these methods can be costly, inefficient, or unstable. Water splitting using a photocatalyst can provide a clean and renewable energy system as it utilizes water without producing greenhouse gases. However, many technical challenges exits in developing an efficient stable photocatalyst. One challenge has been the inability of photocatalysts containing semiconductors to absorb visible light, which is a large fraction of the sun light spectrum as most semiconductors absorb UV or NIR light. In order to use a large fraction of the sun light spectrum to excite photo-catalyst semiconductors for hydrogen generation, one can either modify the properties of a semiconductor to absorb all possible light below ca. 1.3 eV (the minimum potential needed for water splitting), or convert incoming photons with weaker energy than this 1.3 eV to higher energy (anti-Stoke emission). By way of example, titanium dioxide or modified titanium dioxide semiconductors have been used as photocatalysts as titanium dioxide has the ability to absorb a photon, which creates an electron-hole pair (e-h). The electron can drive the reduction of H⁺ ions to produce H₂ gas, while the hole (h) can drive the oxidation of OH⁻ ions, producing O₂ gas. These type of catalysts, however, suffer in that they do not absorb a large fraction of the light in the visible region of the electromagnetic spectrum, thus there are few solar photons (about 4%) with the needed energy for excitation.

There have been many attempts to improve the adsorption properties of titanium dioxide. These include (i) heterostructures of TiO₂ with low band gap visible light absorbing photo-catalysts (such as Cu₂O, CuO, CoO, CdS, and others), (ii) doping of TiO₂ with metal anions to raise the valence band (VB) (such as C, N, and S anions), (iii) use of visible light absorbing dyes, (iv) use of plasmonic metal nanoparticles such as gold (Au) or silver (Ag) to absorb visible light, and (v) use of up-conversion material such as rare earth materials. An example of TiO₂ modified with an up-conversion material, is described in U.S. Patent Application Publication No. 2014/0147377 to Ho et al., which describes a photocatalyst having a lanthanide/transition metal nanoparticle co-catalyst deposited on the surface of a metal oxide or graphene nanowire, nanosheet, or gyroid structured photocatalyst. Another example of TiO₂ modified with up-conversion material is Fan et al., “Semiconductors with NIR driven upconversion performance for photocatalysis and photoelectrochemical water splitting,” Crystal Engineering Communications, 2014, 16, 3059. Fan et al. describes modification of semiconductors with lanthanides. Many of these catalysts while able to produce hydrogen from water, suffer in that they are costly to manufacture and have limited chemical reactivity, light scattering, surface area, light absorption spectrum and recombination suppression properties, all of which make them inefficient for solar energy conversion.

### SUMMARY OF THE INVENTION

A discovery has been made that solves the problems associated with the use of photocatalyst for water-splitting reactions. The discovery is premised on using (a) hetero-structures of semiconducting materials (e.g., photocatalyst), (b) up-converting multi-luminescent materials, and (c) metal nanoparticles (e.g., plasmonic materials). The photocatalyst of the present invention can have a photoactive semi-conductive layer that encompasses at least a portion of a metal or metal alloy having surface plasmon resonance properties in response to IR light and/or visible light core and an up-converting material capable of capable of converting infrared (IR) light to visible light and/or ultraviolet (UV) light. The photocatalyst can have a core-shell structure or planar type structure. The combination of the materials used, and the resulting structure of the catalysts of the present invention, provides an elegant way to utilize sub-bandgap photons in combination with plasmon excitation to improve the efficiency of photocatalytic processes and the associated costs of performing such processes. Without wishing to be bound by theory, it is believed that this improved efficiency can be obtained through the positioning of the plasmonic materials proximate to the up-converting materials to create an interface (e.g., the interface being a distance of 0 to 20 nm, preferably 0 to 10 nm between the plasmonic and up-converting materials). Still further, the positioning of the photoactive semi-conductive layer proximate (e.g., about 40 nm or less) to the interface between the plasmonic and up-converting materials can further improve efficiency.

In a particular aspect of the invention, a water-splitting photocatalyst is described. The water-splitting photocatalyst can include a photoactive semi-conductive layer; an up-converting material capable of converting infrared (IR) light to visible light and/or ultraviolet (UV) light; and a metal or metal alloy material having surface plasmon resonance properties in response to IR light and/or visible light. The photoactive semi-conductive layer can encompass at least a portion of the up-converting material and the metal or metal alloy material. Without wishing to be bound by theory, it is believed that by positioning the plasmonic metal nanoparticles near the up-converting materials the photonic emissions in the UV will increase the electron-hole pair generation in the photoactive semi-conductive layer, which in turn improves the photocatalytic performance of the photoactive semi-conductive layer. In some aspects of the invention, the photoactive semi-conductive layer has a core-shell structure. The up-converting material can be included in the core, in the photoactive semi-conductive shell, or both. In some aspects, the metal or metal alloy core is coated with the up-converting material. Each of the metal or metal alloy material and the up-converting material can be in the form of micro- or nanostructures, preferably each are in the form of nanoparticles. The photoactive semi-conductive layer can encompass or form a shell around the metal or metal alloy core. In some embodiments, the core is hollow or partially hollow and the metal, metal alloy or up-converting material is in the hollow portion of the nanoparticle. The shell can have one or more layers (e.g., 1, 2, 3, 4, etc.). In a particular embodiment, the shell has 3 layers of photoactive semi-conductive material. The layers can include some of the core material and/or the metal, metal alloy, or up-converting material. In some embodiments, the up-converting material and the metal or metal alloy are deposited on the photoactive semi-conductive layers after all or some of the core material is removed. Such a photocatalyst can be in particulate form. The particles can have a mean particle size of 300 nm or less, less than 100 nanometers (nm), less than 50 nm, less than 40 nm, less than 30 nm, less than 20 nm, or preferably, 5 to 30 nm, or most preferably 5 to 20 nm. In other aspects of the invention, the photocatalyst of the present invention can be a layered film comprising a first layer that includes the metal or metal alloy material, a second layer that includes the up-converting material, and a third layer that includes the photoactive semi-conductive layer, wherein the second layer is positioned between the first and third layers. The first layer can have a thickness of <100 nm, the second layer can have a thickness of <200 nm and the third layer can have a thickness of <1000 nm. The film and/or each of the layers can be substantially planar. In certain aspects of the invention, the photoactive semi-conductive layer includes titanium dioxide. The titanium dioxide can include single phase anatase, single phase rutile, a physical mixture of single phase anatase, and single phase rutile, or a mixed phase of anatase and rutile. When the titanium dioxide is a mixture of anatase and rutile or a mixed phase of anatase and rutile, a ratio of anatase to rutile ranges from 1.5:1 to 10:1, preferably 3:1 to 8:1, and most preferably from 5:1 to 7:1. In some aspects of the invention, the up-converting materials can include metals or metal compound (e.g., oxides) of erbium (Er), thulium (Tm), ytterbium (Yb), uranium (U), holmium (Ho), Lutetium (Lu), and terbium (Tb), or any combination thereof. In some aspects, the up-converting material can be nanocrystals or microcrystals. In some embodiments, the up-converting material is NaYF₄:Yb:Tm (See, for example, FIG. 21). The nano- or microcrystals can be synthesized using a dielectric matrix such as NaYF₄ or NaGdF₄ doped with lanthanide ions such as Yb, Er, Tm in different ratios. The metal or metal alloy material can include silver (Ag), palladium (Pd), platinum (Pt), gold (Au), nickel (Ni), cobalt (Co), Rhodium (Rh), Ruthenium (Ru), Iridium (Ir) and copper (Cu) nanoparticles, or any combination or alloy thereof. In certain aspects of the invention, an electrically conductive material and/or plasmonic material is deposited on the photoactive semi-conductive layer. The electrically conductive material can be a metal (e.g., gold, ruthenium, rhenium, rhodium, palladium, silver, osmium, iridium, platinum, or combinations or alloys thereof, preferably, gold, palladium, or a combination or alloy thereof.). The photoactive semi-conductive layer can include less than 5, 4, 3, 2, 1, 0.5 or 0.1 wt. % of the electrically conductive material and/or the electrically conductive material can cover more than 30, 20, 10, 5, 2, or 1% of the surface area of the photoactive material. In some embodiments, plasmonic materials are electrically conductive. Photocatalysts of the present invention can be self-supported or supported. Supports can include substrate such as glass, a polymer bead, or a metal oxide, or combinations thereof. The photocatalysts of the present invention can be included in a composition that includes water and, optionally, a sacrificial agent (e.g., methanol, ethanol, propanol, iso-propanol, n-butanol, iso-butanol, ethylene glycol, propylene glycol, glycerol, or oxalic acid, or any combination thereof).

In some aspects of the invention, a method of making the photocatalyst is described. The method includes obtaining a silicon dioxide particle or a silicon dioxide particle impregnated with metal or metal alloy particles having surface plasmon resonance properties in response to infrared (IR) light and/or visible light; coating the silicon dioxide particle with a photoactive semi-conductive material; removing the silicon dioxide to form a shell of the photoactive semi-conductive material; and impregnating the shell with an up-converting material capable of converting IR light to visible light and/or ultraviolet (UV) light or metal or metal alloy particles. The metal or metal alloy material can be inside the photoactive semi-conductive material shell, or in the photoactive semi-conductive shell. The silicon dioxide particle can be impregnated with the metal or metal alloy particles with a metal or metal alloy salt solution. A size of the metal or metal alloy particles can be modified by modifying the metal or metal alloy salt concentration of the solution. The up-converting material and/or metal or metal alloy particles can extend through the shell to the surface of the shell.

In another aspect of the invention, a method of making the photocatalyst is described. The method includes obtaining a silicon dioxide particle; coating the silicon dioxide particle with a photoactive semi-conductive material; removing the silicon dioxide to form a shell of the photoactive semi-conductive material; and impregnating the shell with metal or metal alloy particles having surface plasmon resonance properties in response to infrared (IR) light and/or visible light and up-converting particles capable of converting IR light to visible light and/or ultraviolet (UV) light.

In some aspects of the invention a method of making the photocatalyst having a shell-core type structure can include obtaining (a) a solution of metal or metal alloy salts that have surface plasmon resonance properties in response to infrared (IR) light and/or visible light and up-converting particles capable of converting IR light to visible light and/or ultraviolet (UV) light; (b) obtaining a solution of up-converting material capable of converting infrared (IR) light to visible light and/or ultraviolet (UV) light; (c) obtaining a solution of a photoactive semi-conductive material; (d) reacting the solution in step (b) with the solution of step (a) to form a particle having a plasmonic material core and an up-converting material shell; and reacting the particle of step (d) with the solution of step (c) to obtain a photocatalyst having the up-converting material shell is positioned between the plasmonic material core and the photoactive semi-conductive shell.

In yet another aspect of the present invention a method of making the photocatalyst having a shell-core type structure can include (a) obtaining a solution of metal or metal alloy salts having surface plasmon resonance properties in response to infrared (IR) light and/or visible light and up-converting particles capable of converting IR light to visible light and/or ultraviolet (UV) light; (b) obtaining a solution of a photoactive semi-conductive material; reacting the solution in step (b) with the solution of step (a) to form a particle having a plasmonic material core and a photoactive semi-conductive shell; and doping the semi-conductive shell with up-converting material capable of converting infrared (IR) light to visible light and/or ultraviolet (UV) light.

A method of making a photocatalyst of the present invention can include depositing a metal or metal alloy material having surface plasmon resonance properties in response to IR light and/or visible light onto a substrate to form a first layer; depositing a second layer onto a portion of a first surface of the first layer, the second layer comprising an up-converting material capable of converting infrared (IR) light to visible light and/or ultraviolet (UV) light; and depositing a third layer having the photoactive semi-conductive material onto a portion of a first surface of the second layer to obtain a photocatalyst having the second layer positioned between the first and third layers.

In another aspect of the present invention, a system for producing hydrogen gas from water is described. The system can include (a) a container comprising a composition that includes the water-splitting photocatalysts of the present invention described throughout the specification, water, and a sacrificial agent; and (b) a light source for irradiating the composition. Hydrogen gas can be obtained from water subjecting the composition to the light source for a sufficient period of time to produce hydrogen gas from water.

Also disclosed in the context of the present invention are embodiments 1-39. Embodiment 1 is a water-splitting photocatalyst comprising a photoactive semi-conductive layer; an up-converting material capable of converting infrared (IR) light to visible light and/or ultraviolet (UV) light; and a metal or metal alloy material having surface plasmon resonance properties in response to IR light and/or visible light, wherein the photoactive semi-conductive layer encompasses at least a portion of the up-converting material and the metal or metal alloy material. Embodiment 2 is the water-splitting photocatalyst of embodiment 1, wherein the photoactive semi-conductive layer forms a shell, and wherein the metal or metal alloy material is comprised in a core of the shell. Embodiment 3 is the water-splitting photocatalyst of embodiment 2, wherein the up-converting material is comprised in the core of the shell. Embodiment 4 is the water-splitting photocatalyst of embodiment 2, wherein the up-converting material is comprised in the photoactive semi-conductive layer. Embodiment 5 is the water-splitting photocatalyst of any one of embodiments 3 to 4, wherein the metal or metal alloy material and the up-converting material are each micro- or nano-structures. Embodiment 6 is the water-splitting photocatalyst of embodiment 5, wherein the metal or metal alloy material and the up-converting material are each in the form of nano-particles. Embodiment 7 is the water-splitting photocatalyst of embodiment 2, wherein the core is coated with the up-converting material. Embodiment 8 is the water-splitting photocatalyst of any one of embodiments 1 to 7, wherein the photocatalyst is in particulate form. Embodiment 9 is the water-splitting photocatalyst of embodiment 8, wherein the photocatalyst has a mean particle size of less than 100 nanometers (nm), less than 50 nm, less than 40 nm, less than 30 nm, less than 20 nm, or preferably, 5 to 30 nm, or most preferably 5 to 20 nm. Embodiment 10 is the water-splitting photocatalyst of embodiment 1, wherein the photocatalyst is a layered film comprising a first layer that includes the metal or metal alloy material, a second layer that includes the up-converting material, and a third layer that includes the photoactive semi-conductive layer, wherein the second layer is positioned between the first and third layers. Embodiment 11 is the water-splitting photocatalyst of embodiment 10, wherein the first layer has a thickness of less than 100 nm, the second layer has a thickness of less than 200 nm and the third layer has a thickness of less than 1000 nm. Embodiment 12 is the water-splitting photocatalyst of any one of embodiments 10 to 11, wherein the film and/or each of the layers are substantially planar. Embodiment 13 is the water-splitting photocatalyst of any one of embodiments 1 to 13, wherein the photo-active semi-conductive layer comprises titanium dioxide. Embodiment 14 is the water-splitting photocatalyst of embodiment 13, wherein the titanium dioxide comprises single phase anatase or single phase rutile. Embodiment 15 is the water-splitting photocatalyst of embodiment 14, wherein the titanium dioxide comprises a mixture of anatase and rutile. Embodiment 16 is the water-splitting photocatalyst of embodiment 15, wherein the ratio of anatase to rutile ranges from 1.5:1 to 10:1, preferably 3:1 to 8:1, and most preferably from 5:1 to 7:1. Embodiment 17 is the water-splitting photocatalyst of any one of embodiments 15 to 16, wherein the titanium dioxide is a mixed phase of anatase and rutile. Embodiment 18 is the water-splitting photocatalyst of any one of embodiments 1 to 17, wherein the up-converting material comprises erbium (Er), thulium (Tm), ytterbium (Yb), uranium (U), holmium (Ho), lutetium (Lu), and terbium (Tb), or any combination thereof. Embodiment 19 is the water-splitting photocatalyst of any one of embodiments 1 to 18, wherein the metal or metal alloy material comprises silver (Ag), palladium (Pd), platinum (Pt), gold (Au), nickel (Ni), cobalt (Co), Rhodium (Rh), Ruthenium (Ru). Iridium (Ir) and copper (Cu) nanoparticles, or any combination or alloy thereof. Embodiment 20 is the water-splitting photocatalyst of any one of embodiments 1 to 19, wherein an electrically conductive material is deposited on the photoactive semi-conductive layer. Embodiment 21 is the water-splitting photocatalyst of embodiment 20, wherein the electrically conductive material comprises a metal. Embodiment 22 is the water-splitting photocatalyst of embodiment 21, wherein the metal is gold, ruthenium, rhenium, rhodium, palladium, silver, osmium, iridium, platinum, or combinations or alloys thereof. Embodiment 23 is the water-splitting photocatalyst of embodiment 22, wherein the metal is gold or palladium or a combination or alloy thereof. Embodiment 24 is the water-splitting photocatalyst of any one of embodiments 20 to 23, comprising less than 5, 4, 3, 2, 1, 0.5 or 0.1 wt % of the electrically conductive material. Embodiment 25 is the water-splitting photocatalyst of any one of embodiments 20 to 24, wherein the electrically conductive material does not cover more than 30, 20, 10, 5, 2, or 1% of the surface area of the photoactive material. Embodiment 26 is the water-splitting photocatalyst of any one of embodiments 1 to 25, wherein the photocatalyst is self-supported. Embodiment 27 is the water-splitting photocatalyst of any one of embodiments 1 to 26, wherein the photocatalyst is supported by a substrate, wherein the substrate comprises glass, a polymer bead, or a metal oxide. Embodiment 28 is the water-splitting photocatalyst of any one of embodiments 1 to 27, wherein the photocatalyst is comprised in a composition that includes water. Embodiment 29 is the water-splitting photocatalyst of embodiment 28, wherein the composition further comprises a sacrificial agent. Embodiment 30 is the water-splitting photocatalyst of embodiment 29, wherein the sacrificial agent is methanol, ethanol, propanol, iso-propanol, n-butanol, iso-butanol, ethylene glycol, propylene glycol, glycerol, or oxalic acid, or any combination thereof.

Embodiment 31 is the system for producing hydrogen gas from water, the system comprising: (a) a container comprising a composition that includes the water-splitting photocatalyst of any one of claims 1 to 30, water, and a sacrificial agent; and (b) a light source for irradiating the composition. Embodiment 32 is a method for producing hydrogen gas from water, the method comprising obtaining a system of embodiment 31 and subjecting the composition to the light source for a sufficient period of time to produce hydrogen gas from the water. Embodiment 33 is the method of making the photocatalyst of any one of embodiments 1 to 9 and 13 to 30, the method comprising: (a) obtaining a silicon dioxide particle impregnated with metal or metal alloy particles having surface plasmon resonance properties in response to infrared (IR) light and/or visible light; (b) coating the silicon dioxide particle with a photoactive semi-conductive material; (c) removing the silicon dioxide to form a shell of the photoactive semi-conductive material, wherein the metal or metal alloy particles are comprised within the shell; and (d) impregnating the shell with an up-converting material capable of converting IR light to visible light and/or ultraviolet (UV) light. Embodiment 34 is the method of embodiment 31, wherein the silicon dioxide particle from step (a) is impregnated with the metal or metal alloy particles with a metal or metal alloy salt solution. Embodiment 35 is the method of embodiment 32, wherein the size of the metal or metal alloy particles is modified by modifying the metal or metal alloy salt concentration of the solution. Embodiment 36 is a method of making the photocatalyst of any one of embodiments 1 to 9 and 13 to 30, the method comprising: (a) obtaining a silicon dioxide particle; (b) coating the silicon dioxide particle with a photoactive semi-conductive material; (c) removing the silicon dioxide to form a shell of the photoactive semi-conductive material; and (d) impregnating the shell with metal or metal alloy particles having surface plasmon resonance properties in response to infrared (IR) light and/or visible light and up-converting particles capable of converting IR light to visible light and/or ultraviolet (UV) light. Embodiment 37 is the method of making the photocatalyst of any one of embodiments 1 to 9 and 13 to 30, the method comprising: (a) obtaining a solution of metal or metal alloy salts, wherein the metal or metal alloy salts have surface plasmon resonance properties in response to infrared (IR) light and/or visible light and up-converting particles capable of converting IR light to visible light and/or ultraviolet (UV) light; (b) obtaining a solution of up-converting material capable of converting infrared (IR) light to visible light and/or ultraviolet (UV) light; (c) obtaining a solution of a photoactive semi-conductive material; (d) reacting the solution in step (b) with the solution of step (a) to form a particle having a plasmonic material core and an up-converting material shell; and (e) reacting the particle of step (d) with the solution of step (c) to obtain a photocatalyst having a plasmonic material core, the up-converting material shell, and a photoactive semi-conductive shell, wherein the up-converting material shell is positioned between the plasmonic material core and the photoactive semi-conductive shell. Embodiment 38 is the method of making the photocatalyst of any one of embodiments 1 to 9 and 13 to 30, the method comprising: (a) obtaining a solution of metal or metal alloy salts, wherein the metal or metal alloy salts have surface plasmon resonance properties in response to infrared (IR) light and/or visible light and up-converting particles capable of converting IR light to visible light and/or ultraviolet (UV) light; (b) obtaining a solution of a photoactive semi-conductive material; (c) reacting the solution in step (b) with the solution of step (a) to form a particle having a plasmonic material core and a photoactive semi-conductive shell; and (d) doping the semi-conductive shell with up-converting material capable of converting infrared (IR) light to visible light and/or ultraviolet (UV) light. Embodiment 39 is a method of making the photocatalyst of any one of embodiments 1 and 10 to 30, the method comprising: (a) depositing a metal or metal alloy material having surface plasmon resonance properties in response to IR light and/or visible light onto a substrate to form a first layer; (b) depositing a second layer onto a portion of a first surface of the first layer, the second layer comprising an up-converting material capable of converting infrared (IR) light to visible light and/or ultraviolet (UV) light; and (c) depositing a third layer onto a portion of a first surface of the second layer, the third layer comprising a photoactive semi-conductive material, wherein the second layer is positioned between the first and third layers.

The following includes definitions of various terms and phrases used throughout this specification.

“Water splitting” or any variation of this phrase describes the chemical reaction in which water is separated into oxygen and hydrogen.

“Nanostructure” refers to an object or material in which at least one dimension of the object or material is equal to or less than 100 nm (e.g., one dimension is 1 to 100 nm in size). In a particular aspect, the nanostructure includes at least two dimensions that are equal to or less than 100 nm (e.g., a first dimension is 1 to 100 nm in size and a second dimension is 1 to 100 nm in size). In another aspect, the nanostructure includes three dimensions that are equal to or less than 100 nm (e.g., a first dimension is 1 to 100 nm in size, a second dimension is 1 to 100 nm in size, and a third dimension is 1 to 100 nm in size). The shape of the nanostructure can be of a wire, a particle, a sphere, a rod, a tetrapod, a hyper-branched structure, or mixtures thereof.

“Microstructure” refers to an object or material in which at least one dimension of the object or material is equal to or less than 1000 microns and greater than 100 nm (e.g., one dimension is greater than 100 nm and less than 1000 microns in size). In a particular aspect, the microstructure includes at least two dimensions that are equal to or less than 1000 microns and greater than 100 nm (e.g., a first dimension is greater than 100 nm and less than 1000 microns in size and a second dimension is greater than 100 nm and less than 1000 microns in size). In another aspect, the microstructure includes three dimensions that are equal to or less than 1000 microns and greater than 100 nm (e.g., a first dimension is greater than 100 nm and less than 1000 microns in size, a second dimension is greater than 100 nm and less than 1000 microns in size, and a third dimension is greater than 100 nm and less than 1000 microns in size). The shape of the microstructure can be of a wire, a particle, a sphere, a rod, a tetrapod, a hyperbranched structure, or mixtures thereof.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result. By way of example, reducing the likelihood for an excited electron in the conductive band to recombine with a hole in the valence band encompasses situations where a decrease in the number of electron/hole recombination events occurs or an increase in the time it takes for an electron/hole recombination event to occur such that the increase in time allows for the electron to reduce hydrogen ions rather than to recombine with its corresponding hole. In either instance, the photocatalysts of the present invention can be compared with photocatalysts of other rare earth metal TiO₂ photocatalyst or noble metal catalysts.

The term “effective,” as that term is used in the specification and/or claims, means adequate to accomplish a desired, expected, or intended result.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The photocatalysts of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the photoactive catalysts and materials of the present invention are their ability to efficiently use excited electrons in water-splitting applications to produce hydrogen.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is schematic of irradiation of the photocatalyst of the present invention with light.

FIG. 2A depicts a schematic of a spherical structure of a hollow photocatalyst of the present invention having one coating of photoactive semiconductor layer.

FIG. 2B depicts a schematic of a spherical structure of a hollow photocatalyst of the present invention having three coatings of photoactive semiconductor layer.

FIG. 2C depicts a schematic of a spherical structure of a hollow photocatalyst of the present invention having three coatings of photoactive semiconductor layer and plasmonic materials on the surface of the outer layer.

FIG. 2D depicts a schematic of a spherical structure of a hollow photocatalyst of the present invention having three coatings of photoactive semiconductor layer without up-converting materials.

FIG. 3 depicts a schematic of a core-shell structure of the photocatalyst of the present invention.

FIG. 4A depicts a schematic of the photocatalyst of the present invention having a layered structure.

FIG. 4B depicts a schematic of the photocatalyst of the present invention having a layered structure with electrically conductive materials on the surface of the photocatalyst.

FIG. 5 is a schematic of a method to prepare a photocatalyst of the present invention having a hollow spherical structure.

FIG. 6 is a schematic of another method to prepare a photocatalyst of the present invention having a hollow spherical structure.

FIG. 7 is schematic of a sol-gel method to make the core-shell structured photocatalyst of the present invention.

FIGS. 8A and 8B are schematics of making layered photocatalysts of the present invention.

FIG. 9 is a schematic of a water-splitting system using the photocatalysts of the present invention.

FIG. 9A is an enlargement of the surface of the photocatalyst in FIG. 9.

FIG. 10 is a Transmission Electron Microscopy (TEM) image of colloidal SiO₂ particles (300 nm in size) at 0.5 μm and 100 nm scales.

FIG. 11 is a TEM image of SiO₂ core nano-particles of 300 nm size, on which one coating of TiO₂ was deposited at 0.5 μm and 100 nm scales.

FIG. 12 are TEM images of SiO₂ core nano-particles of 300 nm size, on which three coatings of TiO₂ was deposited at 0.5 m and 100 nm scales.

FIG. 13 are TEM images of hollow TiO₂ particles of the present invention at 0.5 μm and 100 nm scale.

FIG. 14 is a dark field TEM image of hollow TiO₂ particles of the present invention at a 0.1 μm scale.

FIG. 15 is an Energy Dispersive X-ray Analysis (EDA) of the SiO₂ (core) TiO₂ (shell)—one coating.

FIG. 16 is an EDA of the SiO₂ (core) TiO₂ (shell)—three coatings.

FIG. 17 is an EDA of the hollow TiO₂ nanoparticles of the present invention.

FIG. 18 shows the UV-Vis spectra of a comparative sample of 2 wt. % Au on SiO₂ and 2 wt. % Au deposited on the hollow TiO₂ nanoparticles of the present invention.

FIG. 19 depicts photocatalytic reactions for hydrogen production from water as function of time at 320 to 600 nm with the 2 wt. % Au deposited on the hollow TiO₂ nanoparticles photocatalyst.

FIG. 20 depicts photocatalytic reactions for hydrogen production from water as function of time at 400 to 600 nm with the 2 wt. % Au deposited on the hollow TiO₂ nanoparticles photocatalyst.

FIG. 21 shows a scanning electron micrograph of NaYF₄:Yb:Tm up-converting material of the present invention.

FIG. 22 is a graph predicting the trend of hydrogen production in (mol/gi min) for a photocatalyst, photocatalyst and plasmonic material and a photocatalyst of the present invention as planar and/or shell-core structures.

FIG. 23 is a graph of results of hydrogen production as a function of UV light intensity.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

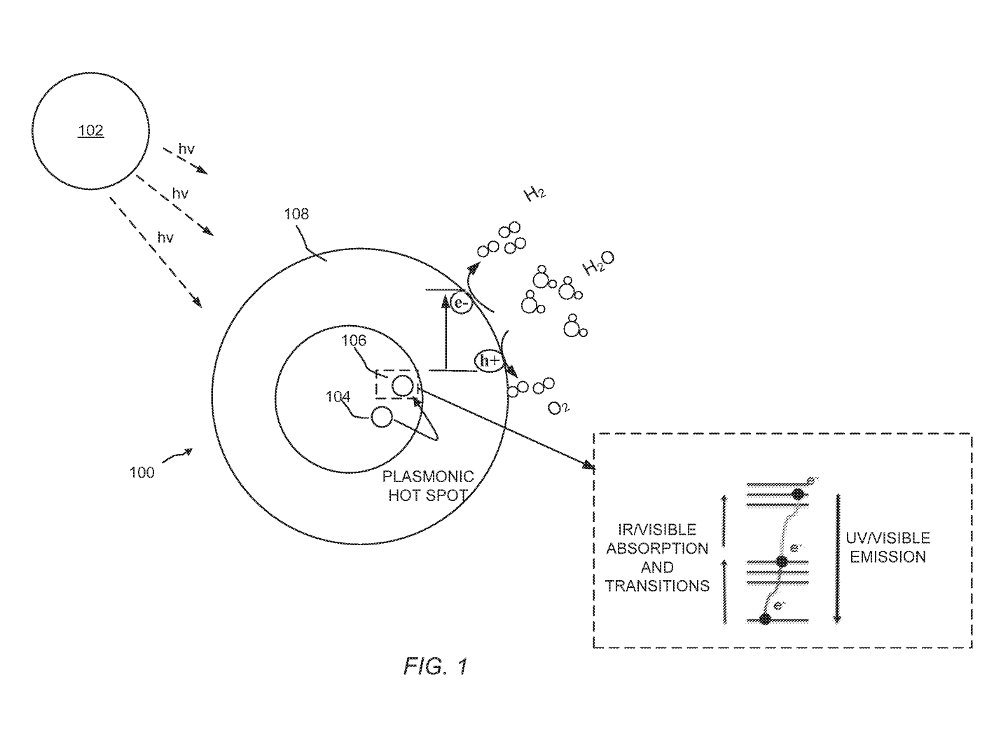

Many of the currently available photocatalysts for water-splitting processes are expensive, inefficient and/or unstable. The present application provides a solution to these issues. The solution is predicated on a photocatalyst composed of (a) hetero-structures of semiconducting materials, (b) up-converting multi-luminescent materials, and (c) metal nanoparticles to utilize sub-bandgap photons and plasmon excitation to improve efficiency of photo-catalytic processes. FIG. 1 depicts a schematic of the response of the photocatalyst to irradiation. Irradiation of photocatalyst 100 with light source 102 (e.g., sunlight) can allow plasmonic material 104 to generate a local electric filed near the surface of plasmonic material 104. The electric field intensity of local plasmonic “hot spots” can be as much as 1000 times the incident electric field. Without wishing to be bound by theory, it is believed that the generation of the local plasmonic electric field enhances the interface between the plasmonic materials and the up-converting materials, and improves the efficiency of the up-conversion process. The up-converting materials 106 positioned near the plasmonic materials can convert near infrared (NIR) and ultraviolet (UV) light to visible light as shown in the electron diagram in FIG. 1i The UV/visible emissions of the up-converting materials are then absorbed by the photoactive semi-conductive material 108 of the photocatalyst. The photoactive semi-conductive material can absorb electromagnetic radiation having energy greater than the energy band gap (E>Eg), which promotes electrons from the valence band (VB) of the semiconductor material into the conduction band (CB) of the semiconductor material, giving rise to electron-hole pairs (e⁻-h⁺). The electrons and holes can migrate to the surface of semiconductor particles and participate in surface reduction or oxidation reactions, or recombination reactions.

These and other non-limiting aspects of the present invention are discussed in further detail in the following sections with reference to the Figures.

### A. Photoactive Catalysts

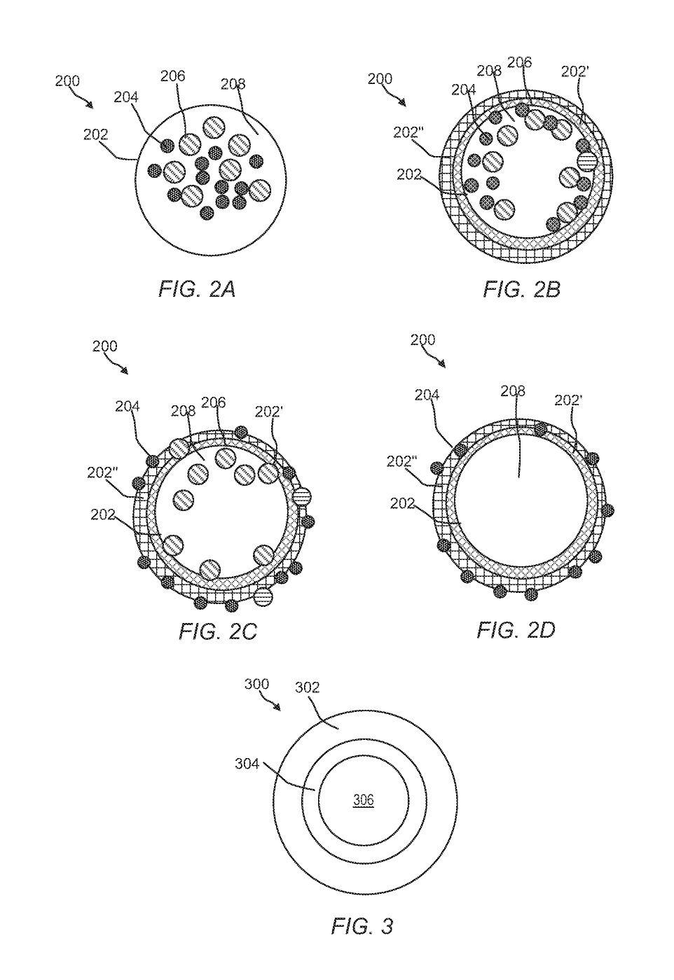

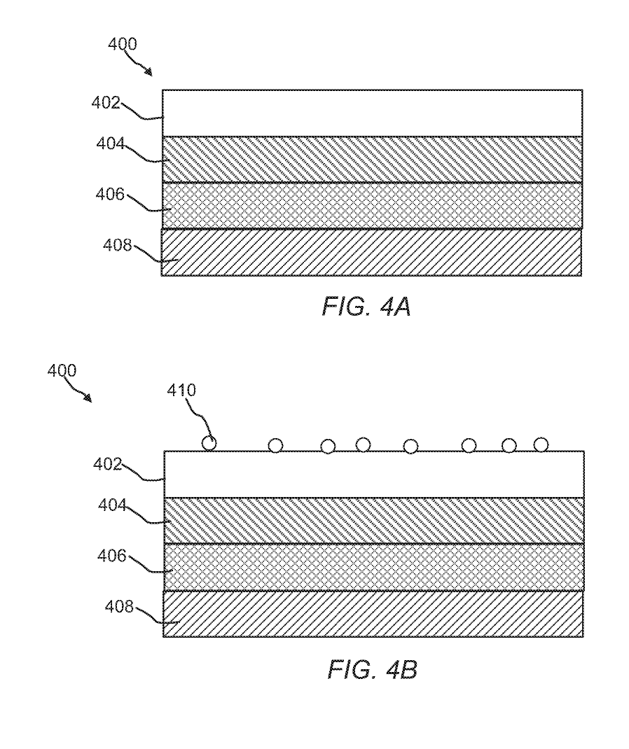

The photoactive catalysts of the present invention include a photoactive semi-conductive material, an up-converting material and metal or metal alloy nanoparticles that have plasmon resonance capabilities. The photocatalyst can have a spherical form or be a layered film. FIG. 2 depicts a schematic of a spherical form of the photocatalyst of the present invention. FIG. 3 depicts a schematic of a core-shell structure of the photocatalyst of the present invention. FIG. 4 depicts a schematic of the photocatalyst having a layered structure. Referring to FIGS. 2A and 2B, the photocatalyst 200 can have photoactive semi-conductive material layer 202, up-converting materials 204 and plasmonic materials and/or electrically conductive materials 206. As shown, the up-converting particles 204 are smaller than the plasmonic materials 206, however, it should be understood that the particle size of the up-converting materials 204 and the plasmonic materials 206 can have the same or different sizes (e.g., the up-converting materials can be larger in size than the plasmonic materials). The photoactive semi-conductive layer 202 forms a hollow sphere in which the up-converting materials 204 and the plasmonic materials 206 are positioned in or encompassed by the hollow portion 208 of the sphere. Referring to FIG. 2B, the photocatalyst 200 can have multiple layers (e.g., 2, 3, 4, etc.) of the photoactive semi-conductive layers 202, 202′, 202″ that encompass the hollow portion 208 that include the up-converting materials 204 and the plasmonic materials 206. In some embodiments, the photoactive semi-conductive layer 202″ can include the core material (e.g., SiO₂). Referring to FIG. 2C, plasmonic materials 206 are impregnated in and/or deposited on the surface of the photoactive semi-conductive layer 202″ and up-converting materials 204 are in the hollow portion and are impregnated in and/or deposited on the surface of the photoactive semi-conductive layer 202″. Thus, the photoactive semi-conductive layer encompasses at least a portion of the up-converting material and the plasmonic material (e.g., metal or metal alloy material). Referring to FIG. 2D, plasmonic materials 206 are impregnated in and/or deposited on the surface of the photoactive semi-conductive layer 202″. Referring to FIG. 3, the photocatalyst 300 can have a core-shell structure that includes photoactive semi-conductive layer 302, up-converting material 304 and plasmonic material 306. As shown, up-converting material 304 is between plasmonic material 306 and photoactive semi-conductive layer 302. The photocatalysts as shown in FIGS. 2 and 3 can have a mean particle size of 300 nm or less, 200 nm or less, less than 100 nm, less than 90 nm, less than 80 nm, less than 70 nm, less than 60 nm, less than 50 nm, less than 40 nm, less than 30 nm, less than 20 nm, or preferably, 5 to 30 nm, or most preferably 5 to 20 nm. The photocatalyst can be in particulate form or powdered form.

Referring to FIG. 4A, the photocatalyst as a layered film is depicted. FIG. 4B depicts the photocatalyst 400 with electrically conductive materials on the surface of photocatalyst. Referring to FIG. 4A, photocatalyst 400 can include a photoactive semi-conductive layer (third layer) 402, a second layer 404 that includes up-converting material 404, a first layer 406 that includes plasmonic material, and a substrate 408. In some embodiments, substrate 408 is not necessary. Substrate 408, in some non-limiting embodiments, can be a polymer, polymer bead glass, glass, a polymer bead, a metal oxide, etc. Referring to FIG. 4B, photocatalyst 400 can include a photoactive semi-conductive layer (third layer) 402, a second layer 404 that includes up-converting material 404, a first layer 406 that includes plasmonic material, electrically conductive materials 410, and a substrate 408. The layers can have the same or different thicknesses. The first layer 406 that includes the plasmonic materials can have with a thickness of less than 100 nm, less than 90 nm, less than 80 nm, less than 70 nm or less than 50 nm. The second layer 404 that includes the up-converting materials can have a thickness of less than 200 nm, less than 190 nm, less than 180 nm, less than 170 nm, less than 160 nm, or less than 150 nm, or less than 50 nm, or less than 10 nm. The photoactive semi-conductive layer (third layer) 402 can have a thickness of less than 1000 nm, less than 900 nm, less than 800 nm, less than 600 nm, or less than 500 nm. Each layer or film can be substantially planar. The electrically conducting material 410 can be nanostructures that are deposed on the surface of the third layer 402. Deposition can include attachment, dispersion, and/or distribution of the layers or metal particles on the surface of each respective layer. As shown in FIGS. 2-4B, the photoactive semi-conductive material encompasses the up-converting materials and the plasmonic materials. The photoactive semi-conductive material, up-converting material, plasmonic material and electrically conductive material shown in FIGS. 2-4B can be any one of the materials described below or in other sections of the specification. The photocatalyst can be made by any one of the methods described throughout the specification or by methods exemplified in the Examples.

1. Photoactive Semi-Conductive Material

The photoactive semi-conductive material includes any semiconductor material able to be excited by light in a range from 360-600 nanometers, 320 to 600, or 400 to 600. In a preferred embodiment, the photoactive material is titanium dioxide. Titanium dioxide can be in the form of three phases, the anatase phase, the rutile phase, and the brookite phase. Anatase and rutile phases have a tetragonal crystal system, whereas the brookite phase has an orthorhombic crystal system. While anatase and rutile both have a tetragonal crystal system consisting of TiO₆ octahedra, their phases differ in that anatase octahedras are arranged such that four edges of the octahedras are shared, while in rutile, two edges of the octahedras are shared. These different crystal structures result in different density of states (DOS) may account for the different efficiencies observed for transfer of charge carriers (electrons) in the rutile and anatase phases and the different physical properties of the catalyst. For example, anatase is more efficient than rutile in the charge transfer, but is not as durable as rutile. Each of the different phases can be purchased from various manufactures and supplies (e.g., titanium (IV) oxide anatase nano powder and titanium (IV) oxide rutile nano powder in a variety of sizes and shapes can be obtained from Sigma-Aldrich® Co. LLC (St. Louis, Mo., USA) and from Alfa Aesar GmbH & Co KG, A Johnson Matthey Company (Germany)); all phases of titanium dioxide from L.E.B. Enterprises, Inc. (Hollywood, Fla. USA)). They can also be synthesized using known sol-gel methods (See, for example, Chen et al., Chem. Rev. 2010 Vol. 110, pp. 6503-6570, the contents of which are incorporated herein by reference).

In one aspect of the invention, mixed phase titanium dioxide anatase and rutile may be a transformation product obtained from heat-treating single phase titanium dioxide anatase at selected temperatures. Heat-treating the single phase titanium dioxide anatase nanoparticle produces small particles of rutile on top of anatase particles, thus maximizing the interface between both phases and at the same time allowing for a large number of adsorbates (water and ethanol) to be in contact with both phases, due to the initial small particle size. Single phase TiO₂ anatase nanoparticles that are transformed into mixed phase TiO₂ nanoparticles have a surface area of about 45 to 80 m²/g, or 50 m²/g to 70 m²/g, or preferably about 50 m²/g. The particle size of these single phase TiO₂ anatase nanoparticles is less than 95 nanometers, less than 50 nm, less than 20, or preferably between 10 and 25 nm. Heat treating conditions can be varied based on the TiO₂ anatase particle size and/or method of heating (See, for example. Hanaor et al. in Review of the anatase to rutile phase transformation, J. Material Science, 2011, Vol. 46, pp. 855-874), and are sufficient to transform single phase titanium dioxide to mixed phase titanium dioxide anatase and rutile. Other methods of making mixed phase titanium dioxide materials include flame pyrolysis of TiCl₄, solvothermal/hydrothermal methods, chemical vapor deposition, and physical vapor deposition methods. Using a ratio of anatase to rutile of 1.5:1 or greater can substantially increase the photocatalytic activity of the semiconductor material. The mixed phase TiO₂ nanoparticles of the present invention can have a ratio of anatase and rutile phase ranges from 1.5:1 to 10:1, from 3:1 to 8:1, or from 5:1 7:1, from 6:1 to 5:1, from 5:1 to 4:1, or from 2:1. Without wishing to be bound by theory, it is believed that this ratio and the particle structure may allow for the efficient transfer of charge carriers (electrons) from the rutile phase to the anatase phase, where said charge carriers in the anatase phase have an increased chance of being transferred to the metal conducting materials rather than undergoing an electron-hole recombination event.

2. Up-Converting Material

The up-converting material is a material that can generate one high-energy photon for every two or more incident low-energy photons. In particular, the up-converting material has the ability to transform unused red and near-infrared radiation into useable UV-Vis light. Up-converting materials can include organic and inorganic materials. Non-limiting examples of organic materials include porphyrin macrocycles/polyflourenes and TiO₂/dye combinations. Non-limiting examples of inorganic materials include the lanthanides (atomic numbers 57-71) and the actinides (atomic numbers (89-103). In a preferred embodiment, the up-converting materials are metals or metal compounds of erbium (Er), thulium (Tm), ytterbium (Yb), uranium (U), holmium (Ho), Lutetium (Lu), and terbium (Tb), or any combination thereof in their +3 oxidation state (e.g., Er⁺³, Tm⁺³, U⁺³, Ho⁺³, Lu⁺³, and Tb⁺³). Up-converting materials or salts thereof can be obtained through commercial chemical suppliers. In some aspects, the up-converting material can be nanocrystals or microcrystals synthesized using a dielectric matrix such as NaYF₄ or NaGdF₄ doped with lanthanide ions such as Yb, Er, Tm in different ratios. A non-limiting example of an up-converting material is NaYF₄:Yb:Tm (See, for example, FIG. 21). A non-limiting example of a commercial supplier of up-converting materials is Sigma-Aldrich® Co. LLC (St. Louis, Mo., USA. Without wishing to be bound by theory, it is believed that the up-converting material utilizes a “ladder” formation of discrete energy levels from an ion. By absorbing lower energy photons, an electron is able to “step up” to higher energy levels (e.g., see FIG. 1). If two steps or more are made and the electron then drops back to the ground state (“falls off the ladder”), then a photon may be emitted with a greater energy than any of the initially absorbed photons. Lanthanides have multiple luminescent energy levels, which do not substantially deviate when doped into different materials due to shielded electron levels. In lanthanide ions, the intermediate states that lead to up-converted emission are 4f orbital energy levels. These 4f orbitals are shielded from the outside chemical environment by outer-lying 6s and 6p orbitals and do not participate in bonding to a significant degree. The f orbital states therefore effectively maintain their atomic character, and electric dipole transitions between them remain parity-forbidden. Non-radiative decay can be suppressed by embedding the ions in a host structure with low energy phonon modes. As a result, the excited states are metastable, enabling long-lived intermediate states that then allow for sequential energy transfers to the photoactive semi-conductive material.

3. Plasmonic Materials

The plasmonic materials of the present invention can be a metal or metal alloy having surface plasmon resonance properties in response to infrared light and/or visible light. Non-limiting examples of the metal or metal alloy includes silver (Ag), palladium (Pd), platinum (Pt), gold (Au), nickel (Ni), cobalt (Co), Rhodium (Rh), Ruthenium (Ru), Iridium (Ir) and copper (Cu) nanoparticles, or any combination or alloy thereof. Without wishing to be bound by theory, it is believed that irradiating metal nanoparticles with light at their plasmon frequency can generate intense electric fields at the surface of the nanoparticles. The frequency of this resonance can be tuned by varying the nanoparticle size, shape, material, and proximity to other nanoparticles. For example, the plasmon resonance of silver, which lies in the UV range, can be shifted into the visible range by making the nanoparticles larger. Similarly, it is possible to shift the plasmon resonance of gold from the visible range into the IR by increasing the nanoparticle size. In some aspects, the average nanoparticle size of the nanoparticle ranges from 5 to 15 nm, 6 to 12 nm, 8 to 10 nm, or 5 to 10 nm. Metal or metal alloys can be obtained from a commercial supplier such as Sigma-Aldrich® Co. LLC (St. Louis, Mo., USA).

4. Electrically Conductive Materials

In some instances, electrically conductive materials can be deposited on the photoactive semi-conductive layer. Non-limiting examples of electrically conductive materials include gold, ruthenium, rhenium, rhodium, palladium, silver, osmium, iridium, platinum, or combinations or alloys thereof. Some electrically conductive materials can also be plasmonic materials. In certain embodiments, the electrically conductive material is in the form of nanostructures. The nanostructures can be nanoparticles having an average particle size of less than 1 nm to 25 nm, preferable 0.5 nm to 20 nm, or most preferably 1 nm to 10 nm or 0.05 nm, 0.5 nm, 0.6 nm, 0.7 nm, 0.8 nm, 0.9 nm, 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm or any value or range there between. The nanostructures can be nanowires, nanoparticles, nanoclusters, or nanocrystals, or combinations thereof. In a preferred embodiment, the electrically conductive material is gold, silver or both or an alloy of both. The photocatalyst may include about 0.05 wt. % to about 5 wt. % of the electrically conductive material. Such amounts can be less than 5, 4, 3, 2, 1, or 0.5 wt. % of the total weight of the photocatalyst. Electroconductive material (i.e., platinum, gold, silver, and palladium) can be obtained from a variety of commercial sources in a variety of forms (e.g., solutions, particles, rods, films, etc.) and sizes (e.g., nanoscale or microscale). By way of example, Sigma-Aldrich® Co. LLC and Alfa Aesar GmbH & Co KG offer such products. Alternatively, they can be made by any process known by those of ordinary skill in the art.

### B. Methods of Making the Photocatalyst

The photocatalyst can be prepared using known catalyst preparation methods (e.g., precipitation/co-precipitation, impregnation, sol-gel, templates/surface derivatized metal oxides synthesis, solid-state synthesis, of mixed metal oxides, microemulsion technique, solvothermal, sonochemical, combustion synthesis, etc.). Methods to prepare the photocatalyst are discussed in further detail in the following sections.

1. Method to Make Photoactive Semi-Conductive Hollow Spheres Encompassing Nanostructures of Up-Converting and Plasmonic Materials

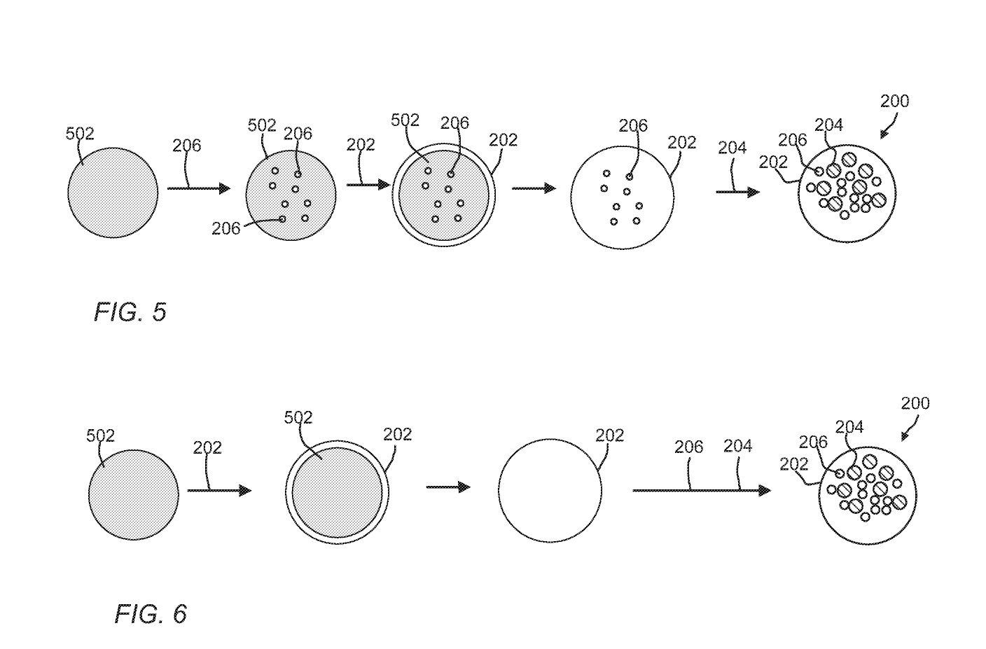

A hollow sphere structured photocatalyst of the present invention (e.g., the catalyst 200 in FIGS. 2A-2D) can be prepared using template methodology. FIG. 5 is a schematic of a method to prepare photocatalyst 200, which has photoactive semi-conductive layer (hollow spheres) encompassing up-converting and plasmonic materials. A templating agent 502 (e.g., silicon dioxide (SiO₂) nanoparticles) can be used for making a hollow sphere structure with up-converting material 204 and plasmonic material 206, respectively, positioned in the center of hollow (opening) and then removed. A salt solution of plasmonic material 206 (e.g., Au/Ag salt solution) can be impregnated into the template nanoparticles. In some instances, the pores of the nanoparticles of the template 502 (e.g., SiO₂ pores of less than 10 nm) can be cleaned by thermal treatment at 300° C. for 4 h under vacuum, (e.g., 10⁻³ mbar). The maximum volume of plasmonic material 206 salt solution added is equivalent to the cumulative pore volume of the silica particles. Thus, the particle size of the plasmonic metal or metal alloy is directly related to the plasmonic material salt concentration of the solution. By way of example, increased concentrations of the plasmonic material 406 salt in the solution can result in larger the particle sizes. In some embodiments, the plasmonic material 406 is not added to the template 502. After impregnation of the plasmonic material 206, a photoactive semi-conductive (TiO₂) layer 202 is added to the template-plasmonic material nanoparticles such that the photoactive semi-conductive layer encompasses the template and the plasmonic material. In non-limiting example, a very slow addition of an alcoholic solution of photoactive semi-conductive 202 precursor material (e.g., a Ti ethoxides or titanium tert-butoxides in ethanol solution) can be added to the silica/plasmonic material nanoparticles. The resulting template-plasmonic material nanoparticles encompassed with photoactive semi-conductive material can be heat treated (e.g., calcined at 300-500° C. for 2-5 hours) in air to remove any organic matter that is present and form template/plasmonic material nanoparticles having a photoactive semi-conductive layer (template/plasmonic material-photoactive semi-conductive nanoparticles). In some embodiments, the samples are not heat treated. To make multiple layered particles (e.g., FIGS. 2B-2D), the alcoholic solution of photoactive semi-conductive 202 precursor material can be added to a particle having the template core/photoactive semi-conductive shell (e.g., SiO₂@TiO₂). The coated particle can then be washed and ultrasonically treated to prevent aggregation. This addition, washing and ultrasonic treatment can be repeated until the desired numbers of layers (e.g., layers 202′ and 202″) are coated on the template core (e.g., SiO₂).

In some instances, when TiO₂ is used as the photoactive semi-conductive material, the TiO₂ can be crystalized in its anatase phase during the heat treatment. After heat treating, the templating agent can be removed (e.g., by digesting the template) under conditions suitable to remove all, or substantially all, of the templating agent, without damaging the hollow photoactive semi-conductive layer and keeping the plasmonic materials in the resulting hollow sphere of the photoactive semi-conductive sphere. In some embodiments, the removal (e.g., digestion) is done using aqueous base (e.g., NaOH, KOH or the like). IN some embodiments, some of the core material remains and/or is deposited on the surface of the photoactive semi-conductive layer. After removal of the templating agent, the up-converting material 204 and/or the plasmonic material 206 can be added to the hollow spheres of the photoactive semi-conductive material to form the photocatalyst 200. For example, lanthanide oxides (e.g., Ho, Er, Tm, Yb, and Lu) or metals or metal alloys (e.g., Au, Ag or Au/Ag) can be deposited into the hollow spheres and/or impregnated in the surface of TiO₂ by a dry or wet impregnation process. In some embodiments, the incorporation of the plasmonic material (e.g., metal or metal alloy) can be done before or after the lanthanide incorporation.

2. Method to Make Photoactive Semi-Conductive Hollow Spheres Encompassing Micro-Nanostructures of Up-Converting and Plasmonic Materials

A hollow sphere structured photocatalyst 200 can be prepared using template methodology. FIG. 6 is a schematic of a method to prepare photocatalyst 200, which has photoactive semi-conductive layer (hollow spheres) encompassing up-converting and plasmonic materials. A templating agent 502 can be used for making a hollow sphere structure with up-converting material 204 and plasmonic material 206 positioned in the center of the hollow (opening) portion of the catalyst A photoactive semiconductive (TiO₂) layer 202 is added to the template 502 nanoparticles to coat (encompass) the template 502. For example, a solution of the templating 502 precursor material (e.g., tetraethyl orthosilicate and ammonia solution) can be dispersed in a mixture of hydroxypropyl cellulose, ethanol and water. The photoactive semi-conductive 206 precursor material, (e.g., titanium tert-butoxide) can be added to the dispersion. The resulting template material encompassed with photoactive semi-conductive material can be heat treated in air (e.g., calcined at 500° C. for 5 hours) to remove any organic matter that is present and form template having a photoactive semi-conductive layer. In some instances, when TiO₂ is used as the photoactive semi-conductive material, the TiO₂ can be crystalized in its anatase phase during the heat treatment. After heat treating, the templating agent can be removed (e.g., by digesting the template) under conditions suitable to remove all, or substantially all, of the templating agent, without damaging the hollow photoactive semi-conductive layer. In some embodiments, the removal is done using aqueous base (e.g., NaOH, KOH or the like). After removal of the templating agent, the up-converting material 204 and plasmonic material 206 can be added to the hollow spheres of the photoactive semi-conductive material to form the photocatalyst 200. For example, lanthanide oxides (e.g., Ho, Er, Tm, Yb, and Lu) and Au/Ag nanoparticles can be added into the hollow spheres of TiO₂ by a dry impregnation process.

3. Method to Make Core-Shell Structured Photocatalysts

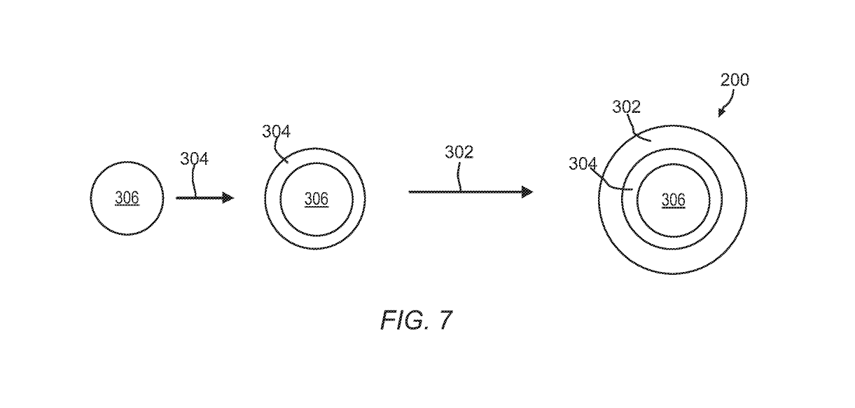

The core-shell structured photocatalyst of the present invention (See, for example, the photocatalyst 300 of FIG. 3) can be made using sol-gel methodology. Sol-gel processing can provide chemical homogeneity, and the formation of metastable structures at low reaction temperatures is attainable. In a sol-gel method, salts of the plasmonic material can be added to a polymeric matrix to form a metal-oxo-polymer network. The resulting precipitates can be amorphous in nature and can then be further heat treated to induce crystallization. The calcination process frequently can result in particle agglomeration and grain growth and may induce phase transformation. FIG. 7 is schematic of a sol-gel method to make the core-shell structured photocatalyst of the present invention. Referring to FIG. 7, small nanoparticles of plasmonic materials 306 (e.g., Au/Ag or Au) can be dispersed in ethanol or 2-propanol and sol-gel synthesis to coat that include the up-converting materials 304 (e.g., rare earth (III) oxides). Another round of sol-gel procedure can be executed to encompass the up-converting and plasmonic materials with the photoactive semi-conductive layer 302. Alternatively, plasmonic nanoparticles 306 can be coated with a shell of photoactive semi-conductive layer 302 using in situ doping with up-converting material 304 (e.g., rare earth elements such as Yb⁺³, Er⁺³ and Tm⁺³ ions).

4. Method to Make Layered Photocatalysts

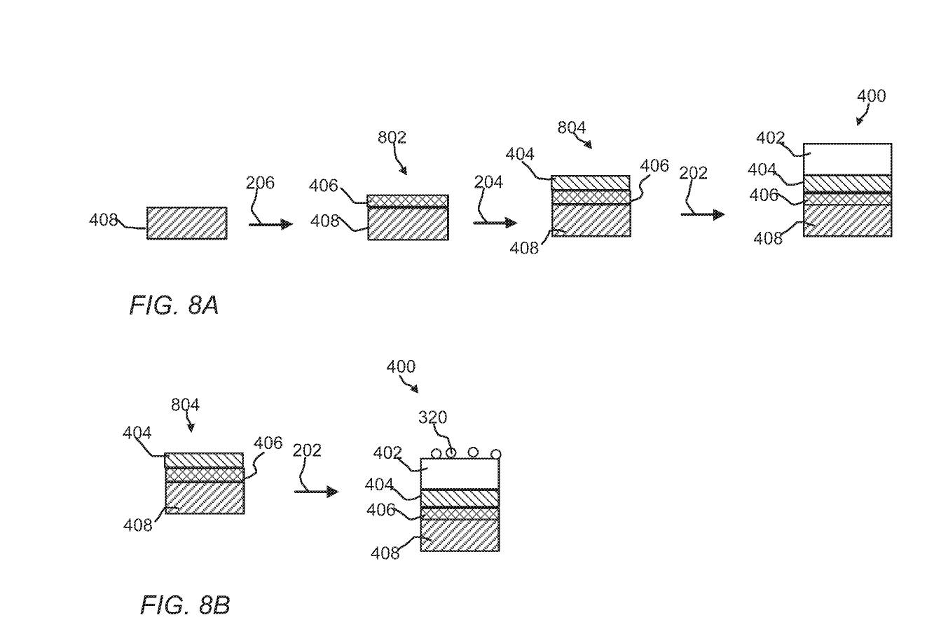

The layered photocatalyst (See, for example, the photocatalyst 400 of FIGS. 4A and 4B) can be made using known film deposition methods. FIGS. 8A and 8B are schematics of making layered photocatalysts. FIG. 8A is a schematic of making a layered photocatalyst having a photoactive semi-conductive layer 402, up-converting material layer 404, plasmonic material layer 406, and substrate 408. FIG. 8B is a schematic of making a layered photocatalyst having a photoactive semi-conductive layer 402, layer 404 that includes up-converting material 204 or 304, layer 406 that includes plasmonic material 206 or 306, substrate 408, and electrically conductive materials 410. The substrate 408 can be obtained or manufactured. A thin film (e.g., <100 nm) of plasmonic material (e.g., Au/Ag or) 206 can be deposited on substrate 408 to form stack 802 having first layer 406 containing plasmonic materials 206. The plasmonic material can be deposited via thermal evaporation, e-beam evaporation or sputtering. The up-converting material 204 can be deposited on the first layer 406 as a thin film (<200 nm) to form stack 804. Stack 804 includes the substrate 408, first layer 406, and second layer 404 that includes the up-converting materials 204. The up-converting materials (for example, lanthanide oxides) can be deposited by sputtering, pulse laser deposition, spin coated, drop casting, etc. Stack 804 can be treated with a photoactive semi-conductive material under deposing (e.g., spin coating, spray coating or sputtering) conditions sufficient to form a film or layer 402 of photoactive semi-conductive layer on layer 404 of the stack to form catalyst 400. Layer 402 has a thickness greater than layers 404 and 406 (e.g., <1 μm or 200 nm to <1 μm). In embodiments, when electrically conductive material is added to layer 402, stack 804 can be subjected to deposing conditions that deposits electrically conductive metals 410 on the surface of layer 402 (See, FIG. 8B) to obtain the photocatalyst of the present invention.

### C. Water-Splitting System

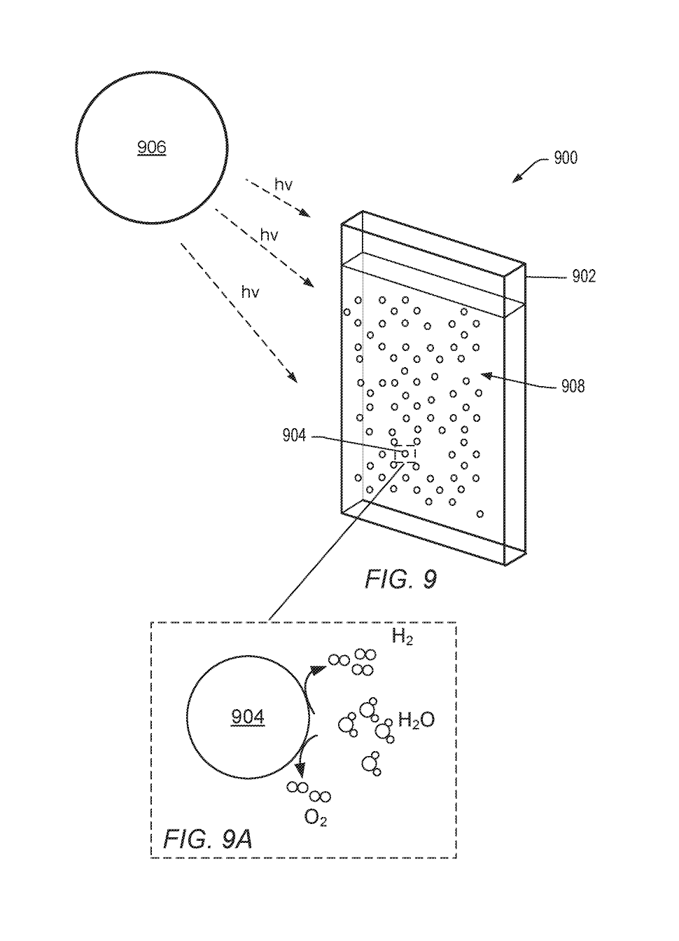

The photocatalysts described throughout the specification can be used to generate hydrogen from water under photolytic conditions. FIG. 9 is a schematic of an embodiment of water-splitting system 900. Water-splitting system 900 includes container 902, photocatalyst 904, light source 906, and water 908. Container 902 can be translucent or even opaque such as those that can magnify light (e.g., opaque container having a pinhole(s)). Photocatalyst 904 is one or more of the photocatalysts described herein and is shown as single nanoparticles dispersed in the media. Light source 906 is sunlight, a UV lamp, or an Infrared (IR) lamp. An example of a UV light is a 100 Watt ultraviolet lamp with a flux of about 2 mW/cm² at a distance of 10 cm. The UV lamp can be used with a 360 nm and above filter. Such UV lamps are commercial available from, for example, Sylvania. Photocatalyst 904 can be used to split water to produce H₂ and O₂ as shown in FIG. 9A, which is an exploded view of the region near a photocatalyst 904 in water-splitting system 900. Light source 906 contacts photocatalyst 904, thereby exciting electrons (e−) from their valence band to their conductive band, thereby leaving corresponding holes (h+). The recombination of these holes is inhibited by the energy produced from the plasmonic materials and the up-converting materials in the photocatalyst (See, for example FIG. 1).

In addition to being capable of catalyzing water splitting without an external bias or voltage, the photocatalysts of the present invention may be included in an anode of an electrochemical cell capable of forming oxygen and hydrogen by electrolysis of water. In a non-limiting example, light energy may be provided to a photocell and from the light energy a voltage between the anode and the cathode is produced and water molecules are split to form hydrogen and oxygen. The method can be practiced such that the hydrogen production rate from water can be modified as desired by subjecting the system to various amounts of light or light flux.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Synthesis of Monodispersed SiO₂ Colloid

A solution of ethanol (215.83 mL), ammonia hydroxide (3.406 g, 28 wt. % NH₄OH) and water (135.36 mL) was prepared and placed in a sealed reactor and heated. Tetraethylorthosilicate (TEOS, 0.4 mol/L) was quickly injected into the hot solution and stirred for 12 to 16 hours. The resulting precipitate was separated from the solution using a centrifuge and washed 3 times with deionized water.

### Example 2

### Synthesis of Core/Shell—SiO₂/TiO₂ Nanoparticles

First, silica particles (3.0 g, 300 nm in diameter) were dispersed in ethanol (250 ml) by ultrasonic treatment. Then distilled water (2.43 g), and hydroxypropyl cellulose ((HPC), 0.9 g, Mw 100,000, Sigma-Aldrich®, U.S.A.), were added with stirring, and then ethanol (35 mL) was added to the solution. Titanium butoxide (12.25 g, TBOT, Ti(OC₄H₉)₄, 97%, Sigma-Aldrich®,) dissolved in ethanol (9.9 g) was introduced slowly using a peristaltic pump. The resulting solution was refluxed at 85° C. for 90 min. The concentrations of titanium butoxide and distilled water in the final solution were 0.12 and 0.45 M, respectively. The titania coated silica particles were collected by centrifugation after washing with ethanol. During the washing step, these samples were ultrasonically treated at 8 W for 10 min by a homogenizer (Model CP505, Cole-Parmer, U.S.A.) to prevent aggregation. The above procedure was repeated several times in order to control the coating thickness of the SiO₂ core/TiO₂ shell nanoparticles. All samples were dried at 100° C. in an oven before further characterization.

### Example 3

### Removal of the SiO₂ Core from the SiO₂ Core/TiO₂ Shell

The SiO₂ core/TiO₂ shell nanoparticles were treated to remove the SiO₂ core and produce hollow TiO₂ nanoparticles using known dissolution methods (e.g., digestion with base such as NaOH).

### Example 4

### Deposition of Gold (Au) on Hollow TiO₂ Nanoparticles

Gold (Au, 2 wt. % based on total catalyst weight) was deposited on the hollow TiO₂ nanoparticles by the deposition impregnation precipitation method described in International Application Publication No. WO 2015/056054 to Idriss et al. on the hollow spheres of TiO₂ (shell) to produce Au impregnated in the hollow TiO₂ nanoparticles of the present invention having most of the SiO₂ core material removed.

### Example 5

### Nanoparticle Characterization

Transmission Electron Microscopy (TEM).

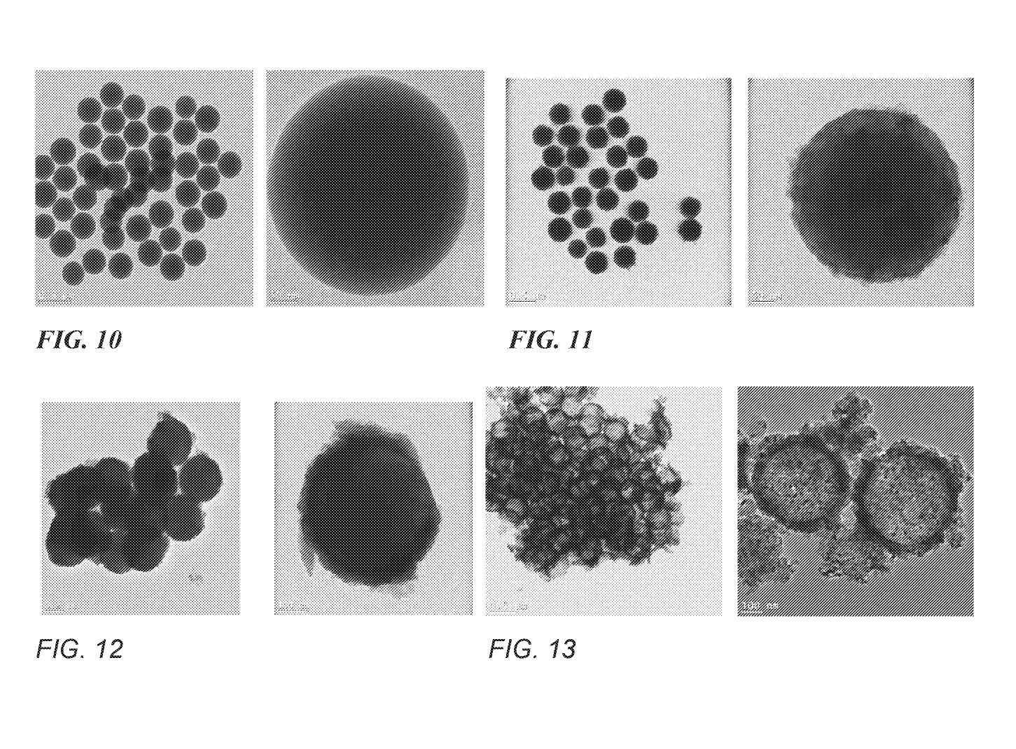

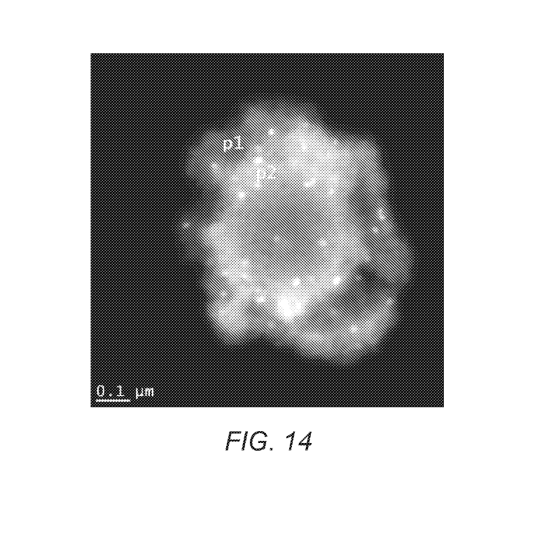

The SiO₂ nanoparticles and SiO₂ core/TiO₂ shell nanoparticles, and hollow TiO₂ particles of Example 3, and the Au/TiO₂ of Example 4 of the present invention were analyzed using TEM. FIGS. 10, 11, 12 and 13 show the TEM images of the SiO₂ nanoparticles (FIG. 10), the SiO₂ core/TiO₂ shell nanoparticles with one TiO₂ coating (FIG. 11), the SiO₂ core/TiO₂ shell nanoparticles with three TiO₂ coatings (FIG. 12), and the hollow TiO₂ nanoparticles (FIG. 13). The SiO₂ nanoparticles were about 300 nm in size. The hollow TiO₂ nanoparticles having three coatings had, on the outer sphere, a thin SiO₂ coating. Having a thin SiO₂ coating on the outer surface of the hollow TiO₂ nanoparticles can be beneficial when Au is deposited as it is poised to enhance the plasmon resonance response of the hollow TiO₂ nanoparticle. FIG. 14 shows a dark filed image of the Au/TiO₂ hollow nanoparticles. In dark field mode, heavy elements appear brighter than light ones (i.e., Au particles are brighter than the other elements). The Au particles sizes were between 5 and 10 nm.

Energy Dispersive X-Ray Analysis (EDA).

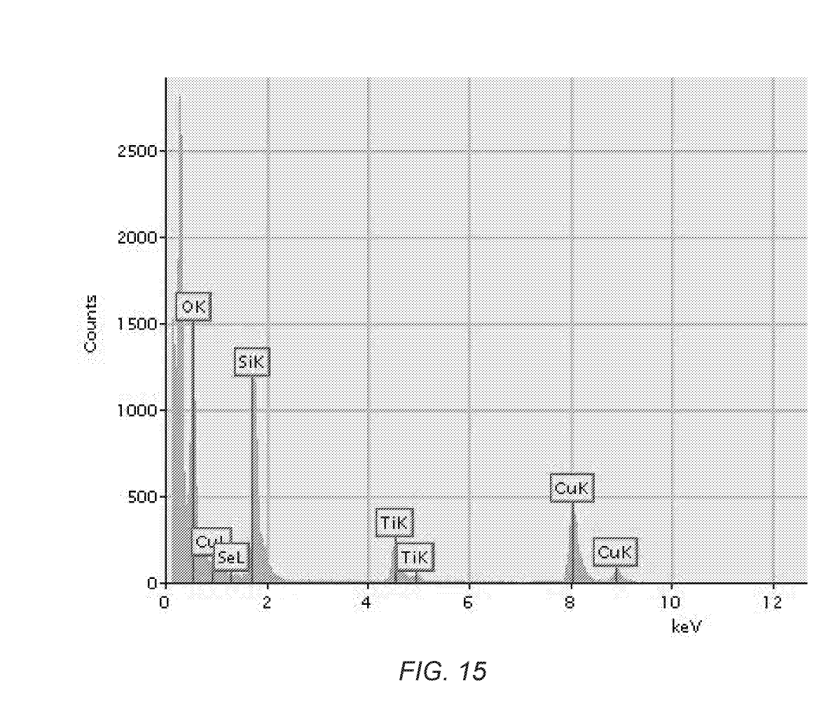

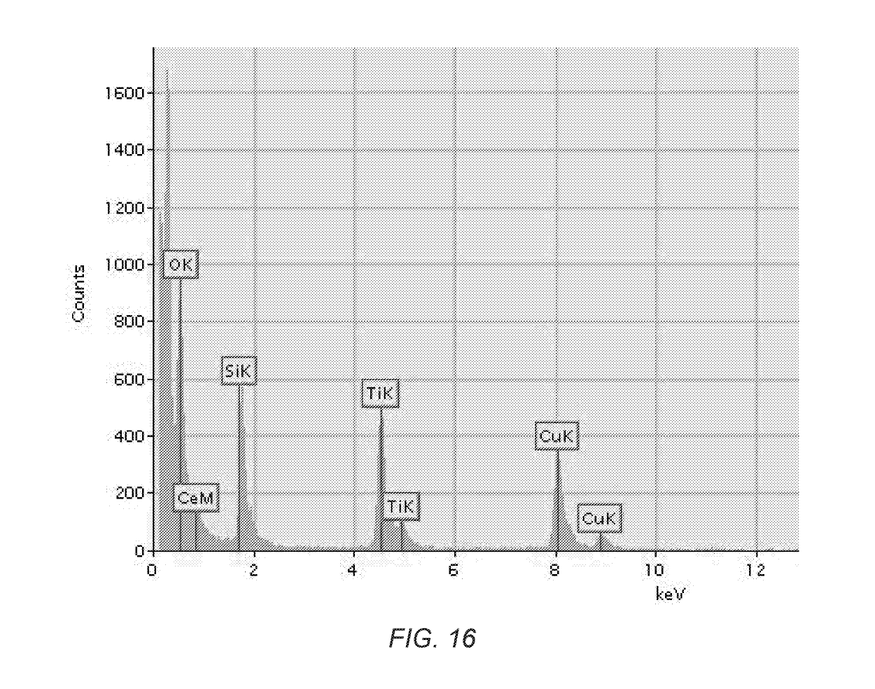

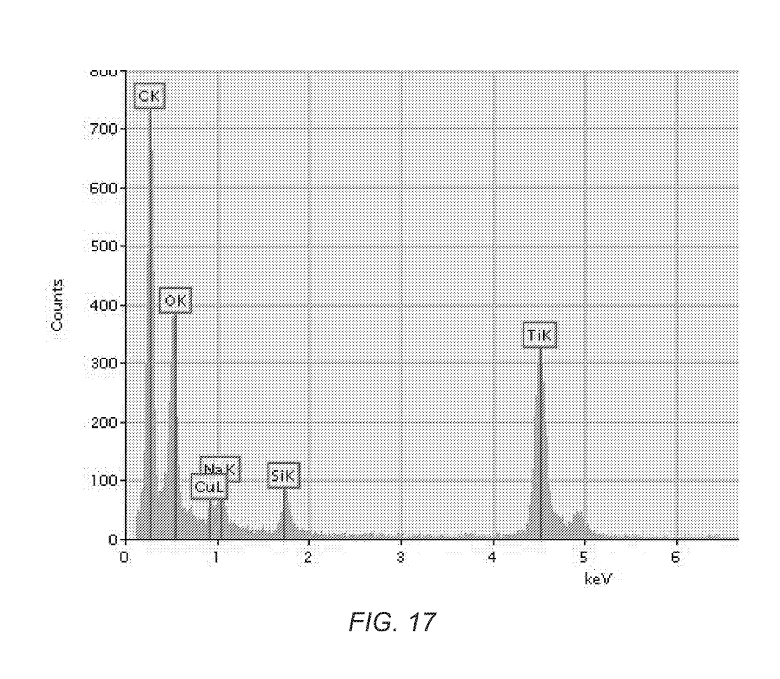

The SiO₂ core/TiO₂ shell nanoparticles were analyzed using EDA. FIGS. 15, 16, and 17 show the EDA spectra of the SiO₂ core/TiO₂ shell nanoparticles with one TiO₂ one coating of (FIG. 15) and two coatings (FIG. 16) and the hollow TiO₂ nanoparticles of Example 3 (FIG. 17).

Ultra-Violet-Visible (UV-Vis).

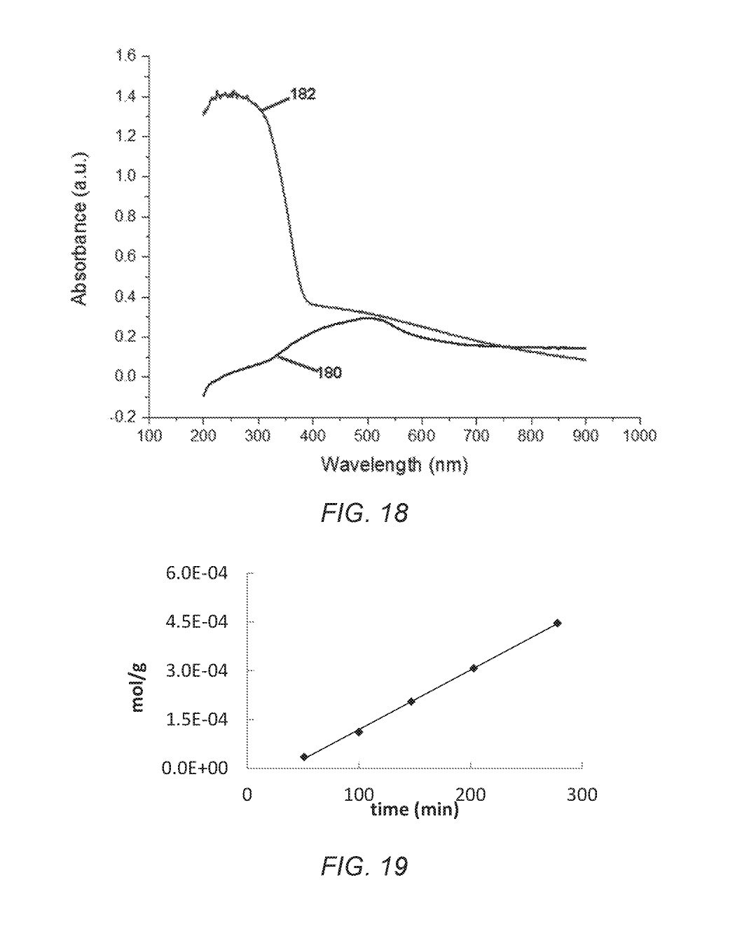

FIG. 18 shows the UV-Vis spectra of a comparative sample of 2 wt. % Au on SiO₂ and 2 wt. % Au impregnated hollow TiO₂ nanoparticles of the present invention (Example 4). Data line 180 is the comparative sample and data line 182 is photocatalyst of the present invention (Example 4). Since SiO₂ is a wide band gap insulator material, it has no absorption in the 200-1000 nm region. The main response was seen as a peak centered at about 550 nm due to Au plasmon resonance. TiO₂ is a wide band gap semiconductor material with an absorption up to about 400 nm. The Au plasmon resonance response was part of the tail of the main TiO₂ absorption from 400 nm and above.

### Example 6

### Core-Shell Structure Testing at Various Wavelengths

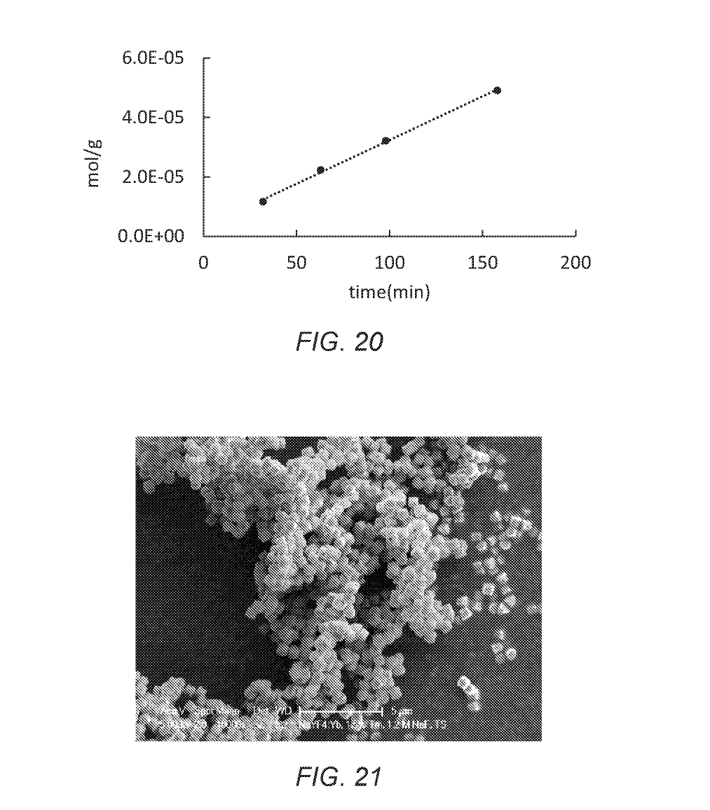

The catalyst of the present invention from Example 4 was tested in a photocatalytic water-splitting reaction under UV-Vis light at various wavelengths. An aqueous solution of Example 4 photocatalyst and 5 vol. % glycerol in a quartz reactor was irradiated under UV-Vis light between 320 and 600 nm, which excites both TiO₂ and Au. The quartz reactor was purged with inert gas such as nitrogen or argon before the photoreaction. The photo activity was tested using a Xenon lamp or solar simulator under light of wavelength from 320 to 620 and 400 to 600 nm to cover UV and Visible IR regions. FIG. 19 depicts photocatalytic reactions for hydrogen production from water as a function of time at 320 to 600 nm. An aqueous solution of Example 4 photocatalyst and 5 vol. % glycerol was irradiated under UV-Vis light between 400 and 600 nm, which excites only Au. FIG. 20 depicts photocatalytic reactions for hydrogen production from water as function of time at 400 to 600 nm. It was observed that the reaction rate (Y-axis/X-axis) was about 15% in 400 to 600 nm test when compared to that obtained with the 320-600 nm. Hydrogen production in this case seemed to be only due to Au particles deposited on the hollow spheres of TiO₂ and benefiting from the presence of the dielectric SiO₂ particles at the edges of the sphere. Hydrogen production rate in this case indicated that Au plasmon boosted the performance of the catalyst in this configuration.

### Example 7

### Up-Converting Material

FIG. 21 shows a scanning electron micrograph of NaYF₄:Yb:Tm up-converting material of the present invention.

### Prophetic Example 8

### Planar and Core-Shell Structures with Up-Converting Material

Glass slides can be coated with plasmonic metal thin films (Au or Ag), then a layer of up-converting microcrystals or nanocrystals, and then finally a TiO₂ photocatalyst. Core-shell structures can be made using the methods described in the specification and the above examples.

### Prophetic Example 9

### Planar and Core-Shell Structure Testing with Up-Converting Material

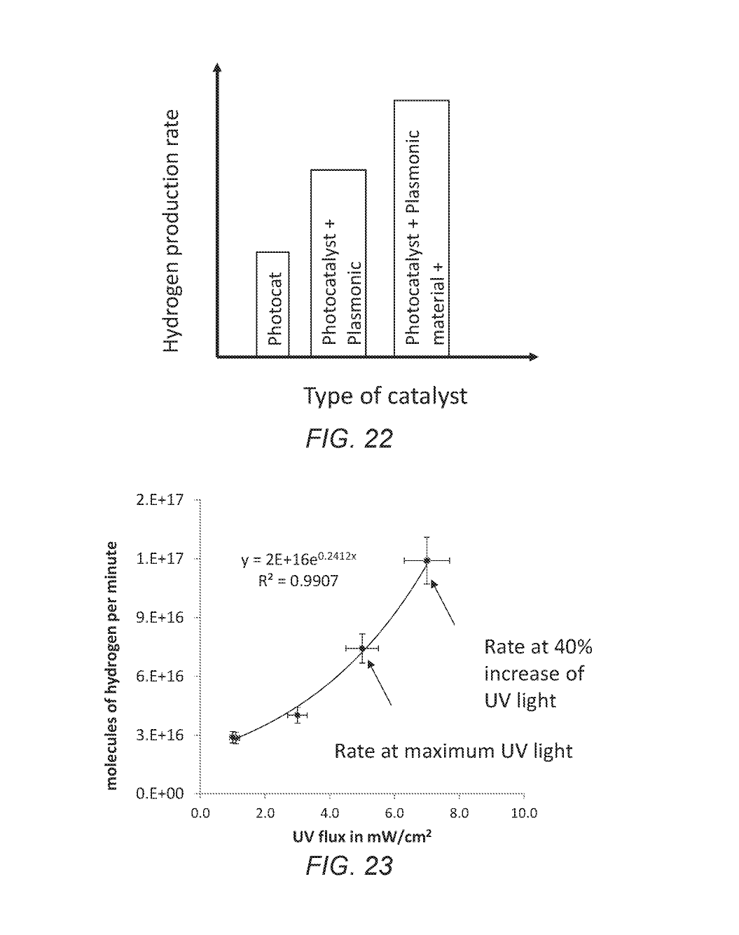

The planar structures and core-shell structures can be tested for water splitting activity using pure water and water-glycerol mixtures. The quartz reactor can be purged with inert gas such as nitrogen or argon before the photoreaction. The photo activity can be tested using a Xenon lamp or solar simulator under light of wavelength from 300-1000 nm to cover UV and Visible IR regions. The different species like H₂, O₂ and CO₂ can be monitored with a GC. FIG. 22 is a graph the trend of hydrogen production in (mol/g_{cataal} min) for a photocatalyst, photocatalyst and plasmonic material and a predicted result of the photocatalyst of the present invention (photocatalyst, plasmonic material and up-converting material).

Without wishing to be bound by theory it is believed that the deposition of the up-converting luminescence material between the photo-catalyst layer (top) and the plasmon layer (bottom) will increase light propagation of high energy needed to excite the photocatalyst. Activity of semi-conductor catalysts containing Pd and Ag on the surface of the catalyst is about 10⁻³ mole/g_{Catal}·min. This activity is obtained upon conversion of most of the UV light provided from the sun (320-400 nm) which represents up to 5% of the solar light. It is predicted that the catalysts of the present invention will increase the performance of the UC luminescent material to an overall efficiency in the UV range of 2% the number of photons increased would be about (95 mW/cm²×0.02). The total flux of the sun is max 100 mW/cm² (the 95 is that of visible plus IR light). Using an approximation of 0.02 as the efficiency, the total increase in the flux in the UV range is about 2 mW/cm². Based on experiments in which the reaction rate is measured as a function of increasing light intensity in the 1 to 10 mW/cm² range, the expected increase in the rate from 5 to 7 mW/cm² would be 1.7-1.8 times. FIG. 23 is a graph of predicted results of hydrogen production as a function of UV light intensity, with catalyst weight of 4 mg, reactor volume of 120 mL, area of catalyst of 1 cm², total liquid of 50 mL, liquid composition of 48.5 mL of water and 1.5 mL of ethylene glycol at 3 vol. %.

1. A water-splitting photocatalyst comprising:
a photoactive semi-conductive layer;
an up-converting material capable of converting infrared (IR) light to visible light and/or ultraviolet (UV) light; and
a metal or metal alloy material having surface plasmon resonance properties in response to IR light and/or visible light,
wherein the photoactive semi-conductive layer encompasses at least a portion of the up-converting material and the metal or metal alloy material.

2. The water-splitting photocatalyst of claim 1, wherein the photoactive semi-conductive layer forms a shell or a layered shell, and wherein the metal or metal alloy material is comprised in a core of the shell, or at least one layer of the shell.

3. The water-splitting photocatalyst of claim 2, wherein the up-converting material is comprised in the core of the shell.

4. The water-splitting photocatalyst of claim 2, wherein the up-converting material is comprised in the photoactive semi-conductive layer or layers.

5. The water-splitting photocatalyst of claim 3, wherein the metal or metal alloy material and the up-converting material are each micro- or nano-structures.

6. The water-splitting photocatalyst of claim 2, wherein the core is coated with the up-converting material.

7. The water-splitting photocatalyst of claim 6, wherein the photocatalyst is a particle and has a mean particle size of 300 nanometers or less.

8. The water-splitting photocatalyst of claim 1, wherein the photocatalyst is a layered film comprising a first layer that includes the metal or metal alloy material, a second layer that includes the up-converting material, and a third layer that includes the photoactive semi-conductive layer, wherein the second layer is positioned between the first and third layers.

9. The water-splitting photocatalyst of claim 8, wherein the first layer has a thickness of less than 100 nm, the second layer has a thickness of less than 200 nm and the third layer has a thickness of less than 1000 nm.

10. The water-splitting photocatalyst of claim 8, wherein the film and/or each of the layers are substantially planar.

11. The water-splitting photocatalyst of claim 1, wherein the photo-active semi-conductive layer comprises titanium dioxide.

12. The water-splitting photocatalyst of claim 1, wherein the up-converting material comprises erbium (Er), thulium (Tm), ytterbium (Yb), uranium (U), holmium (Ho), lutetium (Lu), and terbium (Tb), or any combination thereof, preferably NaYF₄:Yb:Tm.

13. The water-splitting photocatalyst of claim 1, wherein the metal or metal alloy material comprises silver (Ag), palladium (Pd), platinum (Pt), gold (Au), nickel (Ni), cobalt (Co), Rhodium (Rh), Ruthenium (Ru), Iridium (Ir) and copper (Cu) nanoparticles, or any combination or alloy thereof, preferably Au.

14. The water-splitting photocatalyst of claim 1, wherein an electrically conductive material is deposited on the photoactive semi-conductive layer.

15. The water-splitting photocatalyst of claim 1, wherein the electrically conductive material comprises a metal, wherein the metal is gold, ruthenium, rhenium, rhodium, palladium, silver, osmium, iridium, platinum, or combinations or alloys thereof, preferably gold.

16. The water-splitting photocatalyst of claim 16, comprising less than 5, 4, 3, 2, 1, 0.5 or 0.1 wt. % of the electrically conductive material.

17. The water-splitting photocatalyst of claim 16, wherein the electrically conductive material does not cover more than 30, 20, 10, 5, 2, or 1% of the surface area of the photoactive material.

18. The water-splitting photocatalyst of claim 1, wherein the photocatalyst is comprised in a composition that includes water.

19. A method for producing hydrogen gas from water, the method comprising subjecting the composition of claim 18 to a light source for a sufficient period of time to produce hydrogen gas from the water.

20. A method of making the photocatalyst of claim 1, the method comprising:
(a) obtaining a silicon dioxide particle or a silicon dioxide particle impregnated with metal or metal alloy particles having surface plasmon resonance properties in response to infrared (IR) light and/or visible light;
(b) coating the silicon dioxide particle with a photoactive semi-conductive material;
(c) removing the silicon dioxide to form a shell of the photoactive semi-conductive material; and
(d) impregnating the shell with an up-converting material capable of converting IR light to visible light and/or ultraviolet (UV) light and/or metal or metal alloy particles,
wherein at least a portion of the up-converting material, metal or metal alloy particles, or combinations thereof are encompassed by the shell.
